(19) United States
(12) Patent Application Publication
(10) Pub. No.: US 2003/0215481 A1
(43) Pub. Date: Nov. 20, 2003

(54) Control of ticks and fleas of rodents with systemic insecticides and insect growth regulators

(76) Inventors: Jeff N. Borchert, Ft. Collins, CO (US); Richard M. Poche, Wellington, CO (US)

Correspondence Address: Dean P. Edmundson, P. O. Box 179, Burton, TX, 77835, US

(21) Appl. No.: 10/430,708

(22) Filed: May 6, 2003

Related U.S. Application Data
(60) Provisional application No. 60/379,020, filed on May 9, 2002.

(51) Int. Cl. A01N 25/34; A01N 43/04; A01N 25/08; A01N 65/00

(52) U.S. Cl. 424/410; 424/761; 514/29

(57) ABSTRACT

Methods are described for controlling larvae, subadult and adult ticks and fleas on mammals, e.g. rodents. The methods involve feeding a diet composition to mammals in the wild containing a systemic insecticide or insect growth regulator. Optionally, the compositions can also contain a rodenticide.

### CROSS-REFERENCE TO RELATED APPLICATION

This application is based upon, and claims the benefit of, our Provisional Application No. 60/379,020, filed May 9, 2002.

### FIELD OF THE INVENTION

This invention relates to control of ectoparasites. More particularly, it relates to control of larvae, subadult and adult ticks and fleas on rodents with insecticides and insect growth regulators. This invention also relates to control of larvae, subadult and adult ticks and fleas on rodents with insecticides and insect growth regulators in combination with rodenticides to control the mammalian hosts of the ectoparasites.

### BACKGROUND OF THE INVENTION

The use of systemic insecticides and insect growth regulators (IGRS) is an effective way to control the ectoparasites of animals. Because of the many health problems associated with or caused by Lyme disease, plague, tularemia and other diseases carried by fleas and ticks, the control of fleas and ticks which carry the disease is believed to be important.

Considered an Emerging Infectious Disease by the CDC, human Lyme disease cases in the United States have increased about 25-fold since national surveillance began in 1982. The yearly average number of human cases is about 16,000 but in the year 2000 (the most recent data) greater than 17,000 cases of the disease were reported and between 1991-2000 the reported incidence has almost doubled. The CDC reports that Lyme disease accounts for more than 95% of all reported vector-borne illnesses in the U.S. and more than 145,000 human cases have been reported to health authorities. The disease is primarily localized to states in the northeastern, mid-Atlantic, and upper north central regions and to several areas in northwestern California. The tick implicated in the transfer of the spirochete to humans is I. scapularis in the eastern U.S. I. scapularis is in a two year enzootic cycle with small mammals and deer with the most common hosts being the white-footed mouse P. leucopus and the white-tailed deer, Odocoileus virginianus.

Plague has been identified as a category A biological agent. The Orient rat flea, Xenopsylla cheopis, frequently carries the plague bacteria, Yersinia pestus that can be transferred to humans and cause plague. The most common rodent carrier of this flea is the Norway rat, Rattus norvegicus. The plague bacteria is also commonly carried by the flea O. montanus on ground squirrels.

The response to the use of plague as a bioweapon, aerosolized and sprayed over a target population would first involve the treatment and containment of the disease in humans. At risk would be the possibility of the disease infecting commensal (rodents living near humans) rodent populations. If the disease were to progress in rodents, the rodents would suffer mortality, die and their plague carrying fleas would seek new hosts. The likelihood of a secondary wave of human infections from this source would be likely.

The causative agent of tularemaia, Francisella tularensis, exists in nature in a variety of mammals including mice, water rats, voles, rabbits, squirrels and hares. Tularemia is a Category A bioterrorism agent as defined by the CDC. Humans often acquire the disease from the bite of an infectious tick and when epizootics occur in nature among wild populations, die-offs of infected rodents can increase the likelihood of outbreaks in humans.

### SUMMARY OF THE INVENTION

In accordance with the invention there is described a method for effective control of ectoparasites, particularly larvae, subadult and adult ticks and fleas on rodents in the wild. The method includes the use of systemic insecticides and insect growth regulators which are included in bait compositions fed to rodents in the wild. In another embodiment, bait compositions may also include rodenticides.

The method of the invention would also be beneficial in response to the use of other compounds as bioweapons and potentially carried by rodents, e.g. Q fever (a category B biological agent), and tickborne hemmorhagic fever viruses, and tickborne encephalitis (both category C bioterrorism agents) can be maintained in rodents as well as Typhus.

### DETAILED DESCRIPTION OF THE INVENTION

In the present invention, many compounds were evaluated to determine their viability in systemic delivery on wild mammals to control larval I. scapularis (parasitizing deer tick), Xenopsylla cheopis (Oriental rat flea), and Oropsylla montana (ground squirrel flea). Controlling the Ctenocephalides felis (cat flea) on laboratory rats was also demonstrated.

The compounds which were effective for the foregoing purposes included:

Phoxim

α-[[(diethoxyphosphinothioyl)oxy]imino]-benzene-acetonitrile

CAS# 14816-18-3

Cythioate

Phosphorothioic acid O-[4-(aminosulfonyl)phenyl] O,O-dimethyl ester; phosphorothioic acid O,O dimethyl ester O-ester with p-hydroxybezenesulfonamide

CAS# 115-93-5

Fipronil

5-amino-[2,6-dichloro-4-(trifluoromethyl)phenyl]-4-[(1R, S)-(trifluoro=methyl)sulfinyl]-1H-pyrazole-3-carbonitrile

CAS# 120068-37-3

Fenoxycarb

ethyl [2-(4-phenoxyphenoxy)ethyl]carbamate

CAS# 72490-01-8

Ivermectin

Ivermectin consists of not less than 80% 22,23-dihydro-avermectin B₁ₐ and not more than 20% 22,23-dihydroavermectin B_{1b}

Nitenpyram

N-[(6-chloro-3-pyridinyl)methyl]-N-ethyl-N′methyl-2-nitro-=1,1-ethenediamine

CAS# 120738-89-8

Proproxur

2-(1-methylethoxy)phenyl methylcarbamate

CAS# 114-26-11

Selamectin

(5Z,25S)-25-cyclohexy-4′-O-de(2,6-dideoxy-3-O-methyl-*-Larabino-hexopyranoxsyl)-5-demethoxy-25-de(1-methylpropyl)-22,23-dihydro-5-hydroxyiminoavermectin A₁ₐ.

Imidacloprid

1-[(6-Chloro-3-pyridinyl) methyl]-N-nitro-2-imidazolidinimine

CAS# 138261-41-3

Crude Neem Oil

An oil expressed from the seed-kernals of the Indian neem tree, Azadirachta indica

With respect to Lyme disease, the present invention involves a reduction in the competency of the single most competent host (the flea) for I. scapularis. This is preferable to lethal control of the flea host (the white-footed mouse) which would simply cause increased parasitization of other hosts. Thus, the white-footed mouse is a terminal host.

For the homeowner, pest control officer, and lawn care specialist, there has been no other practical means of tick control other than the application of pesticides. The present invention provides these individuals with an alternative choice.

It has been known that exploiting the weak links in the transfer of infection can lead to successful control of vector-borne disease. The method of the present invention, utilizing systemic insecticides and insect growth regulators exploits the weak link in the enzootic cycle and will have substantial effect. Control of other tick-borne diseases (e.g. tularemia) would be accomplished in a similar way by interrupting the tick life cycle.

In response to plague outbreaks or for plague control, controlling flea densities has typically involved the use of spray or powder pesticides applied to the burrow entry of rodents. In the present invention, rodents and their flea burdens are suppressed by the use of rodent baits containing a systemic insecticide or insect growth regulator (IGR) which is consumed by plague-carrying rodents. Fleas attempting to obtain a blood meal then ingest blood containing such compound(s) and receive a lethal dose of the insecticide and die, or if a sufficient amount of IGR is consumed, the growth cycle of the flea is interrupted. Ingestion of bait containing an insecticide or IGR, in sufficient amounts, results in a decrease in the amount of fleas on the rodent. If the population of fleas is reduced in areas of use, the risk of plague in these areas will be reduced. The rodent host can then be controlled by use of the rodenticide, or the bait can also include a rodenticide along with the insecticide or IGR. A bait product of this type would be beneficial for state and federal agencies in response to the use of Yersinia pestis as a bioterrorism agent. Compositions of the type described herein have great societal benefit by giving individuals an effective tool for controlling the risk for epidemics of plague.

The most likely form of attack using plague Y. pestis would be in the form of an aerosol spreading pneumonic form of plague. The plague organism can remain viable as an aerosol for an hour for a distance of up to 10 km. In response to an outbreak of plague, the first response would be treating and controlling the initial infection in humans. Secondary responses would include animal based surveillance to determine if Y. pestis infection in wild mammals and fleas was established. Rodent and flea control would be initiated as well. Rodenticides should not be applied until aggressive flea control is initiated because killing rodents without first eliminating their fleas is likely to increase the human risk for plague as fleas attempt to find new hosts to replace those killed by rodenticides.

Because many cities in the U.S. have documented presence of both the flea and rat vectors of plague, a rodent bait of the type described in this invention would be beneficial in the control of an outbreak of disease secondary to the use of aerosolized plague in a bioterrorism attack. The major benefit of bait compositions of this type will be effective control of both the fleas and their host at the same time. This also involves less risk to workers because the time in the field would be decreased, especially during time of rodent die-off.

To determine the viability of systemically delivered compounds against larval I. scapularis, a study was conducted to determine the efficacy of the organophosphate insecticide, phoxim. This insecticide had been previously evaluated systemically by formulations in rodent baits against X. cheopis in the cotton rat. See Clark and Cole, Oriental Rat Fleas: Evaluation of Three Systemic Insecticides in Baits For Control on Cotton Rats in Outdoor Pens, Journal of Economic Entomology 67(2): 235-236 (1974).

In the present example, bait was mixed using EPA challenge diet (EPA 1991) and phoxim liquid (CAS #14816-18-3) to create a 0.24% phoxim bait. This bait was presented no choice to four laboratory mice, Mus musculus, for 48 hours. Two additional mice were used as controls and were fed EPA challenge diet without the addition of phoxim. After the 48 hour exposure, 40-50 I. scapularis larvae were placed on each mouse. After application, the ticks readily moved into the fur of the mice and all of the ticks had “disappeared” from sight within 5 minutes. The mice were then placed into cages suspended over water in a humidity chamber maintaining room temperature and 80-90% humidity. Each day, for four days, the water beneath the mice was checked for ticks that had fallen from each mouse. Ticks that had fed to repletion were apparent due to their obvious engorgement. These ticks had an elongated “poppy seed” appearance. To observe for adverse reactions associated with organophosphate ingestion, daily observations of mice were made and feed consumption was monitored as well. Data regarding the number of ticks feeding to repletion are summarized in Table 1.

TABLE 1
The Number of Recovered Replete Ticks

| Animal | 24 hours | 48 hours | 72 hours | 96 hours | Total |
|---|---|---|---|---|---|
| Control 1 | 0 | 0 | 5 | 2 | 7 |
| Control 2 | 0 | 0 | 6 | 2 | 8 |
| Treatment 1 | 0 | 0 | 0 | 0 | 0 |
| Treatment 2 | 0 | 0 | 0 | 0 | 0 |
| Treatment 3 | 0 | 0 | 0 | 0 | 0 |
| Treatment 4 | 0 | 0 | 0 | 0 | 0 |
| Treatment 5 | 0 | 0 | 0 | 0 | 0 |

The above data indicate that 0.24% phoxim bait was effective at preventing I. scapularis larvae from feeding on M. musculus mice evidenced by a total of 15 ticks feeding to repletion on two control mice and 0 ticks feeding to repletion on treatment mice. Control mice consumed an average of 3.3 g/day of challenge diet and treatment mice consumed an average of 4.3 g/day of treatment diet. No adverse observations were noted during the test.

Because of its current use as veterinary product and its proven efficacy against Ixodes spp. ticks and fleas, cythioate (CAS #115-93-5) was tested for use in this invention. Following the same method as performed to test the effectiveness of phoxim, a bait was mixed using EPA challenge diet and cythioate to create a 90 ppm cythioate bait. Cythioate was received in the form of 30 mg “Proban” tablets (Boehinger Ingelheim). Three Proban tablets were ground in a mortar and pestle and added to 10 g of powdered sugar. One kilogram of EPA challenge diet was used. Ten grams of corn oil was added to the challenge diet and mixed for 5 minutes on speed 2 using a Kitchenaid mixer. The sugar/Proban mix was added incrementally over 5 minutes. The entire diet was mixed on speed 2 for 5 minutes. The diet was stored frozen when not being used.

The foregoing bait composition was presented no choice to four laboratory mice for 48 hours. One additional mouse was used as a control and was fed EPA challenge diet without the addition of cythioate. After the 48 hour exposure, 40-50 I. scapularis larvae were placed on each mouse. After application, the ticks readily moved into the fur of the mice and all of the ticks had “disappeared” from sight within 5 minutes. The mice were then placed into cages suspended over water in a humidity chamber maintaining room temperature and 80-90% humidity. Each day, for 4 days, the water beneath the mice was checked for ticks that fed to repletion and fallen from the mouse. To observe for adverse reactions associated with cythioate ingestion, daily observations of mice were made and feed consumption was monitored as well. Cythioate diet was fed ad libitum during exposure. Data regarding the number of ticks feeding to repletion are summarized in Table 2.

TABLE 2
The Number of Recovered Replete Ticks

| | | | | 96 | 120 | |
|---|---|---|---|---|---|---|
| Animal | 24 hours | 48 hours | 72 hours | hours | hours | Total |
| Control | 0 | 0 | 3 | 3 | 1 | 7 |
| Treatment 1 | 0 | 0 | 1 | 0 | 0 | 1 |
| Treatment 2 | 0 | 0 | 2 | 1 | 0 | 3 |
| Treatment 5 | 0 | 0 | 2 | 0 | 0 | 2 |

The foregoing data indicate that 90 mg/kg cythioate was somewhat effective at preventing I. scapularis larvae from feeding on M. musculus mice evidenced by a total of 7 ticks feeding to repletion on the control mouse and an average of 2±1 ticks feeding to repletion on the three treatment mice. No adverse observations were noted during the test.

Flea studies were conducted using a number of insect growth regulators, including pyriproxyfen, lufenuron, neem oil and methoprene.

A diet containing 750 ppm pyriproxyfen was mixed and extruded. This diet was presented to 12 laboratory rats (10 treatment and 2 controls) for 24 hours. After 24 hours, flea feeding apparatuses ere attached to each animal containing 20 adult cat fleas. The cat fleas were from a large population with a sex ratio of 60:40 female:male. The position of the apparatus was changed daily. After three days, the apparatus was removed. The caps from the apparatuses were removed and each apparatus was suspended upside down over a small mesh screen. The apparatuses were washed with deionized water to dislodge flea eggs. The flea eggs were collected in the mesh and transferred to a petri dish containing flea media and placed in an incubator. The petri dishes were monitored for flea growth. The results of egg collection are shown in Table 3 below.

TABLE 3

| | | Number | | |
|---|---|---|---|---|
| | | of Fleas | # Flea | # of Eggs |
| Rat | | in | Eggs | Developing |
| Number | Sex | Feeder | Recovered | into Adults |
| T1 | M | 20 | 74 | * |
| T2 | M | 19 | 51 | * |
| T3 | M | 19 | 75 | * |
| T4 | M | 19 | 81 | * |
| T5 | M | 20 | 58 | * |
| T6 | F | 20 | 56 | * |
| T7 | F | 20 | 71 | * |
| T8 | F | 17 | 13 | * |
| T9 | F | 19 | 76 | * |
| T10 | F | 19 | 66 | * |
| | | Total: | 621 | * |
| C3 | F | 18 | 11 | * |
| C4 | M | 19 | 35 | * |
| | | Total: | 46 | * |

*Eggs Still Developing

A diet containing 2730 ppm Lufenuron (Program, Novartis) was formulated using rolled oats, fine corn chop, powdered sugar and corn oil. The diet was exposed to laboratory rats for 24 hours. Ten rats were used as treatment animals and 2 rats were used as controls. After 24 hours, flea feeding apparatuses were attached to each animal containing 20 adult cat fleas. The cat fleas were from a large population with a sex ratio of 60:40 female:male. The position of the apparatus was changed daily. After 2 days, the apparatus was removed, the fleas collected and placed in a clean apparatus which was attached to each rat for 24 hours. After 24 hours, the apparatuses were removed. Flea eggs were then removed from the apparatuses by holding them upside down over a petri dish. The eggs were then transferred to a petri dish containing flea media and placed in the incubator. The petri dishes were monitored for flea growth. The results of egg collection appear in Table 4 below.

TABLE 4
Cat Flea Egg Collection From Fleas Fed on Laboratory
Rats Exposed to Lufenuron Diet

| | | Number | | |
|---|---|---|---|---|
| | | of Fleas | # Flea | # of Eggs |
| Rat | | in | Eggs | Developing |
| Number | Sex | Feeder | Recovered | into Adults |
| T1 | M | 20 | 5 | * |
| T2 | M | 20 | 10 | * |
| T3 | M | 21 | 40 | * |
| T4 | M | 19 | 40 | * |
| T5 | M | 21 | 15 | * |
| T6 | F | 21 | 1 | * |
| T7 | F | 19 | 38 | * |
| T8 | F | 20 | 12 | * |
| T9 | F | 19 | 15 | * |
| T10 | F | 21 | 1 | * |
| | | Total: | 177 | * |
| C3 | F | 21 | 17 | * |
| C4 | M | 20 | 20 | * |
| | | Total: | 37 | * |

*Eggs Still Developing

A diet containing 10000 ppm Neem Oil (Scimetrics) was formulated using rolled oats, fine corn chop, powdered sugar and corn oil. The diet composition was exposed to laboratory rats for 24 hours. Ten laboratory rats were used as treatment animals and 2 rats were used as controls, following the same procedure as described above for the Lufenuron diet. The results of egg collection appear in Table 5 below.

TABLE 5

| | | Number | | |
|---|---|---|---|---|
| | | of Fleas | # Flea | # of Eggs |
| Rat | | in | Eggs | Developing |
| Number | Sex | Feeder | Recovered | into Adults |
| T1 | M | 19 | 22 | * |
| T2 | M | 20 | 25 | * |
| T3 | M | 20 | 32 | * |
| T4 | M | 20 | 6 | * |
| T5 | M | 20 | 31 | * |
| T6 | F | 20 | 18 | * |
| T7 | F | 20 | 13 | * |
| T8 | F | 19 | 18 | * |
| T9 | F | 20 | 21 | * |
| T10 | F | 20 | 36 | * |
| | | Total: | 222 | * |
| C1 | F | 18 | 0 | * |
| C2 | M | 20 | 13 | * |
| | | Total: | 13 | * |

*Eggs Still Developing

A diet containing 1000 ppm Methoprene (ABC Laboratories) was formulated using rolled oats, fine corn chop, powdered sugar and corn oil. The diet was exposed to laboratory rats for 24 hours. Ten rats were used as treatment animals and 2 rats were used as controls. The same procedure was used as is described above in connection with the Lufenuron diet composition. The results of egg collection appear in Table 6 below.

TABLE 6
Cat Flea Egg Collection From Fleas Fed on Laboratory
Rats Exposed to Methoprene Diet

| | | Number | | |
|---|---|---|---|---|
| | | of Fleas | # Flea | # of Eggs |
| Rat | | in | Eggs | Developing |
| Number | Sex | Feeder | Recovered | into Adults |
| T1 | M | 20 | 25 | * |
| T2 | M | 20 | 21 | * |
| T3 | M | 20 | 41 | * |
| T4 | M | 19 | 17 | * |
| T5 | M | 20 | 13 | * |
| T6 | F | 20 | 60 | * |
| T7 | F | 20 | 0 | * |
| T8 | F | 20 | 15 | * |
| T9 | F | 20 | 13 | * |
| T10 | F | 20 | 20 | * |
| | | Total: | 225 | * |
| C3 | F | 20 | 55 | * |
| C4 | M | 20 | 15 | * |
| | | Total: | 70 | * |

*Eggs Still Developing

A number of insecticides were tested against cat fleas. First, a diet composition containing Nitenpyram (Capstar, Novartis) was prepared using rolled oats, fine corn chop, powdered sugar and corn oil. The diet was formulated at 1000 ppm active ingredient and it was exposed to laboratory rats for 24 hours. Ten laboratory rats were used as treatment animals and 2 rats were used as controls. The target dose for each rat was 30 mg/kg. Rats were sedated using acepromazine maleate and approximately 40 fleas were applied to each animal. Fleas on the rats exposed to the diet, and the control animals, were allowed to feed for 24 hours at which point they were collected and observed for mortality. Paper towels were placed under each cage to determine if fleas dying on the animal could be collected underneath the cage. The results for the Nitenpyram appear in Table 7 below. The number of fleas found dead after 24 hours was added to the number of fleas found dead on the paper towel below the cage. Efficacy was determined by dividing the total number of fleas dead by the total number of fleas recovered. The efficacy of a 1000 ppm Nitenpyram diet exposed to laboratory rats for 24 hours was 98.5%. Flea mortality was initially observed one hour after application of fleas to the rats.

TABLE 7

| Rat Number | Sex | Ace Dose (ml) | Active Consumed (mg) | Body Weight (kg) | Dose (mg/kg) | Number of Fleas Applied | $\frac{\# Fleas Dead}{\# Fleas Recovered}$ |
|---|---|---|---|---|---|---|---|
| N1 | M | 0.26 | * | 0.6127 | * | 35 | 5/5 |
| N2 | F | 0.16 | * | 0.3768 | * | 38 | 11/12 |
| N3 | M | 0.24 | * | 0.5713 | * | 35 | 12/12 |
| N4 | M | 0.23 | 16.2 | 0.5472 | 29.6 | 39 | 18/18 |
| N5 | M | 0.31 | 18.7 | 0.7356 | 25.4 | 39 | 20/20 |
| N6 | M | 0.27 | * | 0.6418 | * | 37 | 10/10 |
| N7 | M | 0.26 | 20.1 | 0.6100 | 33.0 | 38 | 13/13 |
| N8 | M | 0.28 | 13.6 | 0.6623 | 20.5 | 37 | 11/11 |
| N9 | M | 0.24 | 19.3 | 0.5731 | 33.7 | 38 | 24/25 |
| N10 | M | 0.26 | * | 0.6304 | * | 39 | 6/6 |
| | | | | | | Total: | 130/132 |
| C1 | F | 0.15 | NA | 0.3744 | NA | 40 | 2/27 |
| C2 | M | 0.25 | NA | 0.6329 | NA | 39 | 0/28 |
| | | | | | | Total: | 2/55 |

*Feed Weighback disposed prior to obtaining weight

A diet composition was prepared using Fipronil (Merial) mixed with rolled oats, fine corn chop, powdered sugar and corn oil. The diet was formulated at 970 ppm active ingredient and then exposed to laboratory rats for 24 hours. Ten laboratory rats were used as treatment animals and two rats were used as controls. The target dose for each rat was 30 mg/kg. The same procedure was used as described above in connection with the Nitenpyram diet composition. The efficacy of the fipronil diet composition was determined to be 100%. The data appears in Table 8 below.

TABLE 8
The Efficacy of Systemic Fipronil on Cat Fleas fed on Laboratory Rats

| Rat Number | Sex | Ace Dose (ml) | Active Consumed (mg) | Body Weight (kg) | Dose (mg/kg) | Number of Fleas Applied | $\frac{\# Fleas Dead}{\# Fleas Recovered}$ |
|---|---|---|---|---|---|---|---|
| T1 | F | 0.08 | 2.2 | 0.1889 | 11.6 | 39 | 5/5 |
| T2 | F | 0.07 | 2.8 | 0.1738 | 16.1 | 40 | 2/2 |
| T3 | F | 0.08 | 2.9 | 0.1964 | 14.8 | 40 | 1/1 |
| T4 | F | 0.07 | 2.7 | 0.1720 | 15.7 | 40 | 6/6 |
| T5 | F | 0.08 | 2.6 | 0.1787 | 14.5 | 40 | 5/5 |
| T6 | M | 0.07 | 4.7 | 0.1560 | 30.1 | 40 | 0/0 |
| T7 | M | 0.08 | 5.2 | 0.1790 | 29.1 | 40 | 1/1 |
| T8 | M | 0.07 | 3.3 | 0.1572 | 21.0 | 40 | 2/2 |
| T9 | M | 0.07 | 2.2 | 0.1730 | 12.7 | 40 | 2/2 |
| T10 | M | 0.07 | 2.9 | 0.1751 | 16.6 | 40 | 8/8 |
| | | | | | | Total: | 32/32 |
| C1 | F | 0.08 | NA | 0.1876 | NA | 40 | 3/7 |
| C2 | M | 0.07 | NA | 0.1635 | NA | 40 | 0/3 |
| | | | | | | Total: | 3/10 |

A diet composition was prepared using cythioate (Proban, Boehinger Ingelheim). The composition was prepared using rolled oats, fine corn chop, powdered sugar and corn oil. The diet was formulated at 1000 ppm active ingredient. The same procedure was used for testing as described above in connection with the nitenpyram composition. The efficacy was determined to be 70.3%. The data appear in Table 9 below.

TABLE 9

| Rat Number | Sex | Ace Dose (ml) | Active Consumed (mg) | Body Weight (kg) | Dose (mg/kg) | Number of Fleas Applied | $\frac{\# Fleas Dead}{\# Fleas Recovered}$ |
|---|---|---|---|---|---|---|---|
| T1 | F | 0.14 | 9.2 | 0.3350 | 27.4 | 28 | 13/26 |
| T2 | F | 0.14 | 8.5 | 0.3383 | 25.1 | 37 | 30/35 |
| T3 | F | 0.15 | 11.9 | 0.3647 | 32.6 | 38 | 24/24 |
| T4 | F | 0.13 | 6.8 | 0.3153 | 21.6 | 40 | 4/22 |
| T5 | F | 0.15 | 1.4 | 0.3453 | 4.1 | 35 | 1/17 |
| T6 | M | 0.27 | 8.2 | 0.6489 | 12.6 | 37 | 16/22 |
| T7 | M | 0.25 | 14.2 | 0.5886 | 24.1 | 40 | 16/22 |
| T8 | M | 0.20 | 8.3 | 0.4866 | 17.1 | 40 | 29/33 |
| T9 | M | 0.26 | 9.4 | 0.6209 | 15.1 | 39 | 27/29 |
| T10 | M | 0.24 | 9.3 | 0.5644 | 16.4 | 38 | 25/33 |
| | | | | | | Total: | 185/263 |
| C1 | F | 0.15 | NA | NA | NA | 35 | 7/21 |
| C2 | M | 0.25 | NA | NA | NA | 39 | 5/17 |
| | | | | | | Total: | 12/38 |

A diet composition was prepared using rolled oats, fine corn chop, powdered sugar, and corn oil. The diet was formulated at 100 ppm selamectin (“Revolution”, from Pfizer) and exposed to laboratory rats for 24 hours. Ten laboratory rats were used as treatment animals and 2 rats were used as controls. The target dose for each rat was 30 mg/kg. Rats were sedated using acepromazine maleate and approximately 40 cat fleas were applied to each animal. Fleas on the rats exposed to the composition, and the control rats, were allowed to feed for 24 hours at which point they were collected and observed for mortality. Paper towels were placed under each cage to collect fleas dying on the animal. The results are shown in Table 10 below.

TABLE 10
The Efficacy of Systemic Selamectin on Cat Fleas fed on Laboratory Rats

| Rat Number | Sex | Ace Dose (ml) | Active Consumed (mg) | Body Weight (kg) | Dose (mg/kg) | Number of Fleas Applied | $\frac{\# Fleas Dead}{\# Fleas Recovered}$ |
|---|---|---|---|---|---|---|---|
| T1 | M | 0.25 | 18.7 | 0.5599 | 33.4 | 37 | 34/34 |
| T2 | M | 0.30 | 13.4 | 0.7036 | 19.0 | 38 | 33/33 |
| T3 | M | 0.25 | 12.4 | 0.5835 | 21.3 | 38 | 26/26 |
| T4 | M | 0.25 | 12.3 | 0.6007 | 20.5 | 39 | 40/40 |
| T5 | M | 0.24 | 2.1 | 0.5772 | 3.6 | 40 | 40/42 |
| T6 | F | 0.16 | 3.9 | 0.3833 | 10.2 | 38 | 21/22 |
| T7 | F | 0.13 | 16.8 | 0.3173 | 52.9 | 39 | 5/5 |
| T8 | F | 0.15 | 17.2 | 0.3677 | 46.8 | 37 | 2/2 |
| T9 | F | 0.15 | 12.2 | 0.3481 | 35.0 | 38 | 6/6 |
| T10 | F | 0.15 | 18.3 | 0.3589 | 51.0 | 38 | 41/41 |
| | | | | | | Total: | 248/251 |
| C3 | F | 0.15 | NA | NA | NA | 38 | 0/14 |
| C4 | M | 0.23 | NA | NA | NA | 38 | 0/16 |
| | | | | | | Total: | 0/30 |

Fleas found dead on the rats were added to the number of fleas found dead on the paper towel below the cage. Efficacy was determined by dividing the total number of dead fleas by the total number of fleas recovered. The efficacy of 1000 ppm selamectin diet was 98.8%.

A 7 day post feeding evaluation of selamectin on the same rats was performed. Approximately 40 cat fleas were applied to the same laboratory rats used in the initial trial. After 24 hours, the fleas were collected. The results appear in Table 11.

TABLE 11
7 Day Post Feeding Efficacy of Systemic
Selamectin on Cat Fleas

| Rat Number | Sex | Ace Dose (ml) | Number of Fleas Applied | $\frac{\# Fleas Dead}{\# Fleas Recovered}$ |
|---|---|---|---|---|
| T1 | M | 0.25 | 38 | 24/24 |
| T2 | M | 0.30 | 40 | 32/32 |
| T3 | M | 0.25 | 39 | 9/18 |
| T4 | M | 0.25 | 37 | 6/12 |
| T5 | M | 0.24 | 37 | 3/31 |
| 16 | F | 0.16 | 38 | 20/25 |
| 17 | F | 0.13 | 38 | 1/1 |
| T8 | F | 0.15 | 37 | 3/3 |
| T9 | F | 0.15 | 38 | 3/3 |
| T10 | F | 0.15 | 39 | 28/28 |
| | | | Total: | 129/177 |
| C3 | F | 0.15 | 40 | 0/12 |
| C4 | F | 0.23 | 38 | 0/28 |
| | | | Total: | 0/30 |

The 7 day post feeding efficacy of a 1000 ppm selamectin diet exposed to laboratory rats for 24 hours was 72.9%.

The same selamectin diet composition prepared in accordance with the foregoing example was exposed to wild Norway rats for 24 hours. Ten rats were used as treatment animals and 2 rats were used as controls. The target dose for each rat was 30 mg/kg. Rats were sedated using acepromazin maleate and approximately 40 Oriental rat fleas (X. cheopis) were applied to each rat. Fleas on the rats exposed to the diet composition, and the control rats, were allowed to feed for 24 hours, after which they were collected and observed for mortality. Paper towels were placed beneath each cage to collect fleas which fell off each animal. The results appear in Table 12 below.

TABLE 12
The Efficacy of Systemic Selamectin on Rat Fleas fed on Wild Norway Rats

| Rat Number | Sex | Ace Dose (ml) | Active Consumed (mg) | Body Weight (kg) | Dose (mg/kg) | Number of Fleas Applied | $\frac{\# Fleas Dead}{\# Fleas Recovered}$ |
|---|---|---|---|---|---|---|---|
| T1 | M | 0.15 | 25.6 | 0.3555 | 72.0 | 40 | 30/30 |
| T2 | M | 0.19 | 20.6 | 0.4437 | 46.4 | NA | NA |
| T3 | M | 0.12 | 13.8 | 0.2962 | 46.6 | 36 | 21/22 |
| T4 | M | 0.18 | 20.6 | 0.4341 | 47.5 | 39 | 24/24 |
| T5 | M | 0.19 | 27.9 | 0.4398 | 63.4 | 40 | 42/44 |
| T6 | M | 0.16 | 24.9 | 0.3896 | 63.9 | 37 | 29/29 |
| T7 | M | 0.17 | 9.1 | 0.4111 | 22.1 | 40 | 27/30 |
| T8 | M | 0.17 | 17.6 | 0.3999 | 44.0 | 40 | 22/23 |
| T9 | M | 0.18 | 19.8 | 0.4326 | 45.8 | 38 | 26/26 |
| T10 | M | 0.15 | 11.4 | 0.3605 | 31.6 | 40 | 21/23 |
| | | | | | | Total: | 242/251 |
| C1 | M | 0.18 | NA | 0.4305 | NA | 40 | 1/12 |
| C3 | M | 0.15 | NA | 0.3687 | NA | 40 | 9/24 |
| | | | | | | Total: | 10/36 |

¹T2 Died during anesthesia procedure

The number of fleas found dead after 24 hours was added to the number of fleas found dead on the paper towel beneath the cage. Efficacy was determined by dividing the total number of dead fleas by the number of fleas recovered. The efficacy of the selamectin diet was determined to be 96.4%.

Other variants are possible without departing from the scope of this invention.

What is claimed is:

1. A method for controlling ectoparasites on mammals comprising orally administering to said mammals in the wild a diet composition comprising a systemic insecticide.

2. A method in accordance with claim 1, wherein said mammals comprise rodents.

3. A method in accordance with claim 2, wherein said ectoparasites comprise larvae, subadult and adult ticks and fleas.

4. A method in accordance with claim 3, wherein said insecticide is selected from the group consisting of phoxim, cythioate, fipronil, fenoxycarb, ivermectin, selamectin, proproxur, imidacloprid, nitenpyram and neem oil.

5. A method in accordance with claim 1, wherein said composition further comprises a rodenticide.

6. A method for controlling ectoparasites on mammals comprising orally administering to said mammals in the wild a diet composition comprising an insect growth regulator.

7. A method in accordance with claim 6, wherein said insect growth regulator is selected from the group selected from pyriproxyfen, lufenuron, neem oil, and methoprene.

8. A method in accordance with claim 6, wherein said composition further comprises a rodenticide.
